(19) United States
(12) Patent Application Publication
(10) Pub. No.: US 2009/0060467 A1
(43) Pub. Date: Mar. 5, 2009

(54) METHOD AND APPARATUS FOR AGGREGATING AND PRESENTING USER PLAYBACK DATA INDICATING MANIPULATION OF MEDIA CLIPS BY A PLURALITY OF USERS

(75) Inventors: Travis M. Grigsby, Austin, TX (US); Frank Jania, Chapel Hill, NC (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,979

(22) Filed: Aug. 29, 2007

(51) Int. Cl. H04N 7/26

(52) U.S. Cl. 386/124

(57) ABSTRACT

User playback data is collected from multiple user media devices. The user playback data indicates how a media clip has been manipulated by the users during playback of the media clip. The collected user playback data is aggregated and presented for display to at least one user, along with the media clip, on a media playback timeline. The media playback timeline indicates manipulation of the media clip by other users and indicates points in time during playback of the media clip that the manipulation of the media clip by the other users occurred. The manipulation of the media clip includes at least one of pause, skip forward, replay, and rewind.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

The present invention relates generally to aggregating data, and, in particular, to aggregating and presenting data indicating manipulation of media.

Devices that allow the playback of media and visualization of the playback through software, hardware, and/or firmware have existed for many years. Lately, these devices have become “data network aware”, so they can pull content from some place other than a removable medium. However, these devices do not provide aggregated user manipulation patterns to users. Moreover, these devices are not aware of the social network of an end user. As a result, they do not offer features to the user that take advantage of the user's social network.

### SUMMARY

According to an exemplary embodiment, a method and apparatus are provided for aggregating and presenting user playback data indicating manipulation of at least one media clip by a plurality of users. User playback data is collected from multiple user media devices. The user playback data indicates how the media clip has been manipulated by the users during playback of the media clip. The collected user playback data is aggregated and presented for display to at least one user, along with the media clip, on a media playback timeline. The media playback timeline indicates manipulation of the media clip by other users and indicates points in time during playback of the media clip that the manipulation of the media clip by the other users occurred. The manipulation of the media clip includes at least one of pause, skip forward, replay, and rewind.

### BRIEF DESCRIPTION OF THE DRAWINGS

Referring to the exemplary drawings, wherein like elements are numbered alike in the several Figures:

FIG. 1 illustrates a system for aggregating and presenting user playback data according to an exemplary embodiment.

FIG. 2 illustrates display of a timeline of user playback data of a media clip, collected from a plurality of users, within the media clip.

FIG. 3 illustrates how aggregated user playback data may be collected and averaged according to an exemplary embodiment.

### DETAILED DESCRIPTION

According to an exemplary embodiment, a method and apparatus allow for the aggregation and display of media manipulation patterns among a plurality of users. According to one aspect, a user is allowed to see, on a media playback timeline displayed within a media clip, at what points during the media clip other users have taken action to pause, replay, skip forward, or otherwise manipulate playback of the media clip. According to another aspect, the aggregated media manipulation data is fed back to a media producer or retailer, as a means for determining the most effective portion of the media to display for limited preview.

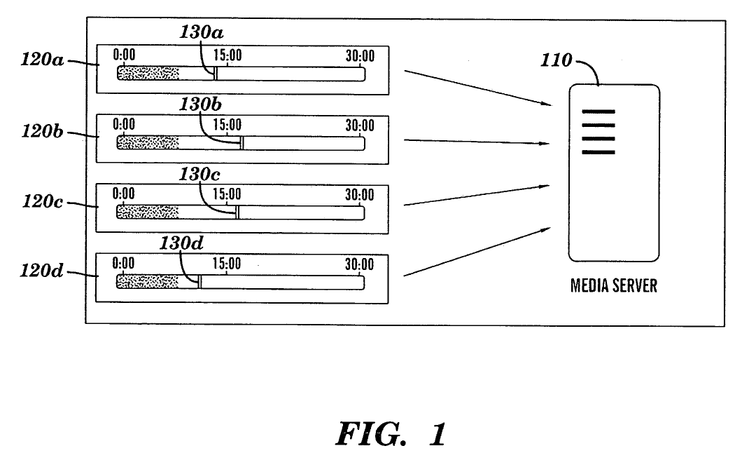

According to an exemplary embodiment, user playback data indicating manipulation of media clips may be aggregated from a plurality of end user devices. This is shown in FIG. 1, which illustrates a media server 110 collecting user playback data indicating manipulation of media clips by various users. The media server 110 may be implemented using a general-purpose media server having, e.g., a microprocessor and/or hardware, software, or a combination of both for performing the technique described herein. The user playback data is represented in FIG. 1 as timeline blocks labeled with reference numerals 120a, 120b, 120c, and 120d. The user playback data 120a, 120b, 120c, and 120d include markers 130a, 130b, 130c, and 130d, respectively, indicating at what points in time during a media clip users manipulated the media clip. In the example shown in FIG. 1, the user playback data 120a, 120b, 120c, and 120d shows at what points in time users started the media clip over from the beginning. However, it should be appreciated that other user playback manipulation data may be collected, e.g., data indicating pausing, skipping forward, etc.

User playback data is collected from a plurality of network-connected devices (not illustrated in FIG. 1 for simplicity of illustration). Although four user playback timelines are shown in FIG. 1, it should be appreciated that user playback data may be collected from any desired number of users from any desired user population. The network-connected devices may include, e.g., digital video recorders (DVRs) that send notice of user playback manipulation of media clips to the media server 110. The network-connected devices may communicate with the media server 110 via a wireless or wireline network, a cable network, the Internet, or any other suitable communication network. The media server 110 then makes the user playback manipulation data available to other end users and/or media providers or retailers.

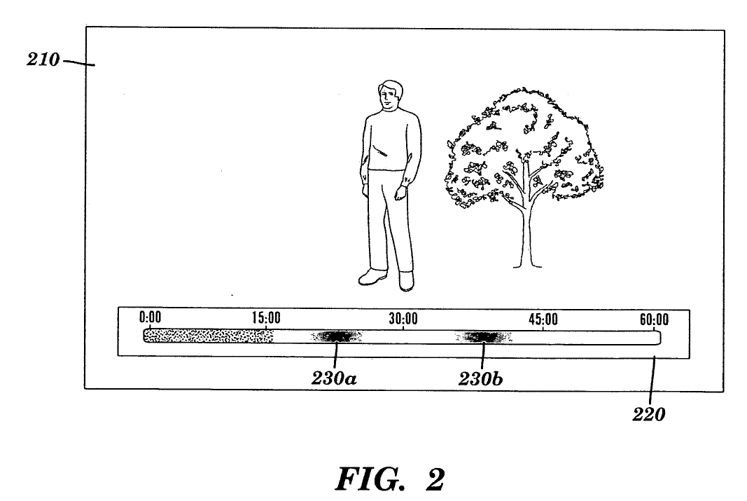

According to one embodiment, the media server may provide the aggregated user playback information to a user. For example, as shown in FIG. 2, a media clip 210 is displayed to a user, along with a media playback timeline 220 indicating at what points in time other users took action with regard to the media clip, such as pausing, replaying, skipping forward, etc. Although a video clip is shown in FIG. 2, it should be appreciated that the technique described herein may apply to any media clip, e.g., an audio clip. As depicted in FIG. 2, based on the input aggregate playback manipulation data, the media server allows the times at which users manipulated the playback of the media clip to be displayed, e.g., as light markers 230a and 230b on the playback timeline 220. In the example shown in FIG. 2, the user may see an aggregate of all of the points in time where other users have pressed the 8-second-replay button on a DVR during playback of a media clip. It should be appreciated that different types of “markers” may be used to indicate manipulation of media clips. These different types of markers may be displayed simultaneously, e.g., to indicate different types of manipulations of the media clip at various points in time.

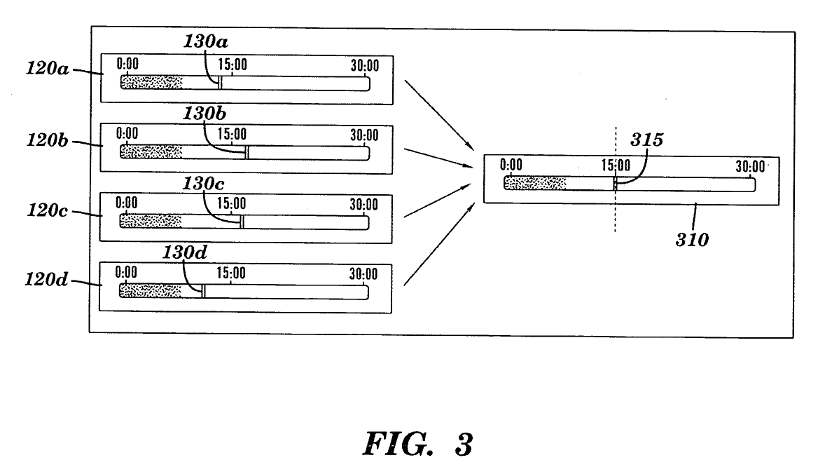

In addition to displaying the aggregated user playback data to an end user, the user playback data may be used to help media producers and/or retailers determine the most popular section of a media clip, e.g., by determining what portion of the media clip is most often replayed from the beginning. For this purpose, the aggregated user playback data may be averaged by the media server 110. An example of this is illustrated in FIG. 3, which shows an average playback timeline 310 of user playback timeliness 120a, 120b, 120c, and 120d. The average playback timeline 310 includes a marker 315 that is an average of the points in time 130a, 130b, 130c, and 130d, respectively, that users started playback of the media clip over from the beginning This technique may be used to determine the best place to start a media clip when a retailer/media producer only exposes a fixed portion of a clip to a potential user or buyer as a limited preview. It should be appreciated that user playback data indicating other manipulation of the media clip may be collected and used by retailers/media producers.

According to an exemplary embodiment, the source of the aggregated data may be an entire user population, in which case data collection may be uniform for all users. As an alternative, data collection may be based on a user's social network, such that the source of the aggregated data may be different for every user. That is, data to be presented to a user may be collected from only those users within the user's social network. This provides the end user with useful information regarding manipulation of media clips by other users that are part of the user's social network. In addition, the position at which a clip starts can be modified over time uniformly for the entire population or may be dynamically generated each time in a unique way for each individual user, based on actions of users within the user's social network.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for aggregating and presenting user playback data indicating manipulation of at least one media clip by a plurality of users, comprising:
collecting user playback data from multiple user media devices, wherein the user playback data indicates how the media clip has been manipulated by the users during playback of the media clip;
aggregating the collected user playback data;
presenting the aggregated user playback data for display to at least one user, along with the media clip, on a media playback timeline, wherein the media playback timeline indicates manipulation of the media clip by other users and indicates points in time during playback of the media clip that the manipulation of the media clip by the other users occurred, and wherein manipulation of the media clip includes at least one of pause, skip forward, replay, and rewind.

2. The method of claim 1, wherein the user playback data is collected uniformly from all the users.

3. The method of claim 1, wherein the user playback data is collected only from user media devices of users that are part of a social network of the user to which the aggregated user playback data is presented.

4. The method of claim 1, further comprising providing the aggregated user playback data to a producer or retailer of the media clip for use in determining a portion of the media clip to display to users as a preview of the media clip.

5. An apparatus for aggregating and presenting user playback data indicating manipulation of at least one media clip by a plurality of users, comprising:
an input for collecting user playback data from multiple user media devices, wherein the user playback data indicates how the media clip has been manipulated by the users during playback of the media clip; and
a processor for aggregating the collected user playback data and presenting the aggregated user playback data for display to at least one user, along with the media clip, on a media playback timeline;
wherein the media playback timeline indicates manipulation of the media clip by other users and indicates points in time during playback of the media clip that the manipulation of the media clip by the other users occurred; and
wherein manipulation of the media clip includes at least one of pause, skip forward, replay, and rewind.

6. The apparatus of claim 5, wherein the user playback data is collected uniformly from all the users.

7. The apparatus of claim 5, wherein the user playback data is collected only from user media devices of users that are part of a social network of the user to which the aggregated user playback data is presented.

8. The apparatus of claim 5, wherein the apparatus provides the aggregated user playback data to a producer or retailer of the media clip for use in determining a portion of the media clip to display to users as a preview of the media clip.
